(19) United States
(12) Patent Application Publication
(10) Pub. No.: US 2008/0054752 A1
(43) Pub. Date: Mar. 6, 2008

(54) Communicator Motor and Method of Manufacturing the Same

(75) Inventors: Akihiko Yamazaki, Fukui (JP); Kazuto Takeda, Fukui (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/576,570

(22) PCT Filed: Nov. 25, 2005
(86) PCT No.: PCT/JP05/22135

§ 371 Date: Apr. 3, 2007

(30) Foreign Application Priority Data
Nov. 26, 2004 (JP) 2004-342206

(51) Int. Cl. H02K 23/38; H01R 39/32; H02K 13/04; H02K 15/09

(52) U.S. Cl. 310/234; 29/597

(57) ABSTRACT

A commutator motor includes a field magnet having a field magnet core and a field magnet winding, and an armature having a rotary shaft, an armature core fixed to the rotary shaft, an armature winding wound on slots of the core, and a commutator. The commutator has commutator segments integer multiples of the number of the slots, and the same number of hooks as the slots. A connecting-wire between the armature winding and the hook is bent and shaped toward the rotary shaft at least at one pace of a start and an end of winding of the armature winding.

### TECHNICAL FIELD

The present invention relates to a commutator motor to be used in a variety of devices such as electrical vacuum cleaners and electric tools, and a method of manufacturing the same commutator motor.

### BACKGROUND ART

Motors have been recently required to operate more efficiently for energy saving because of the environmental protection movement. Commutator motors have been also required to reduce iron-loss and copper-loss in their armatures, which are one of major parts of the commutator motors. This reduction requirement has been pursued as an important subject.

The armature has two main streams; one uses a slit-type commutator, and the other one uses a hook-type commutator. The hook-type commutator involves complicated manufacturing steps, so that the cost thereof increases; however, in winding steps, where the hook-type commutator has been already integrated, quality can be maintained with ease and the number of steps can be simplified comparing with the case where the slit-type commutator is used. The hook-type commutators are thus more widely used.

There are two wire-connection methods between a winding and the hook-type commutator; they are α-shape hooking method shown in FIG. 18 and U-shape hooking method shown in FIG. 19. The difference between these two methods is just a method of wire-connection of connecting wire 62 to hooks 61 provided to commutator 60. As shown in those drawings, the α-shape hooking method is to connect wires in α-shape, and the U-shape hooking method is to connect wires in U-shape. The α-shape method shown in FIG. 18 is more widely used because of better quality and simpler connecting steps.

A motor shown in FIG. 20 for electrical equipment of vehicles includes winding 63A on the slots, and winding 63A is wound at a place outside the outer diameter of commutator 60A. This structure often uses a short α-shape hooking method (hereinafter referred to as “short α-shape method”). The short α-shape method uses connecting-wire 62A which connects winding 63A to commutator hook 61A such that wire 62A runs straight between winding 63A and commutator hook 61A. Since the winding place of winding 63A at the slots is located outside the outer diameter of commutator 60A, wire 62A runs outside an interfering area of the winding. As a result, connecting wire 62A does not interfere with the winding.

On the other hand, a motor shown in FIG. 21 for a vacuum cleaner includes winding 63B placed both inside and outside the outer diameter of commutator 60B. This structure often employs a long α-shape hooking method (hereinafter referred to as “long α-shape method”), which winds connecting wire 62B continued from winding 63B on a rotary shaft and connects to hook 61B, so that wire 62B does not interfere with the next winding.

Use of thicker wire in the winding has been promoted in order to reduce copper-loss of the armature. However, the outer diameter of the commutator is limited due to various requirements to the products equipped with the motors such as downsizing and reducing weight, so that intervals between the hooks are also limited, which is accompanied by not only a physical limitation but also quality limitation on a diameter of the winding hooked on the commutator's hooks. This is one of disadvantages of the hook-type commutator. In order to overcome this disadvantage, two narrow wires having a total diameter equivalent to the thick wire have been used instead of one thick wire in the electrical equipment of vehicles or electrical tools. Motors used in vacuum cleaners also increasingly employ the two narrow wires instead of the thick one.

The long α-shape method widely used for the hook-type commutator is a space-saving hooking method. According to this method, a connecting wire is wound on the rotary shaft between the commutator and the core within a limited space, so that the wire on a coil-end near the commutator becomes thick and the copper-loss increases. As a result, the efficiency is disadvantageously lowered. In order to overcome this drawback, i.e. the coil-end becomes thick due to the connecting wire by the long α-shape method, the short α-shape method free from the thick coil-end is used, and yet, methods of improving its original disadvantage, i.e. a connecting wire straightly stretched between the winding and the hooks interferes with the next winding, are studied. Japanese Patent Unexamined Publication No. H11-27907 discloses one of these improving methods.

In the course of progress of motor efficiency, thicker wire and downsizing of the armature are to be indispensably achieved. As discussed previously, use of two narrow wires having a total diameter equivalent to a thicker one is effective as a method of thickening a wire in the hook-type commutator. To be more specific, a regular winding can be repeated twice by using two wires in parallel, so that parallel wire-connection in two rows to the commutator hooks are achieved, namely, a twice winding method is employed. If this twice winding method is used in the long α-shape method, connecting wires as much as two times volumes are wound in a space limited between the commutator and the core, so that the coil-end near the commutator becomes further thicker. The connecting wire per se is not needed for performing the characteristics, so that the copper-loss increases disadvantageously at a longer connecting wire.

The improved short α-shape method discussed previously is useful only to the model having a winding place on the slot outside the outer diameter of the commutator as shown in the drawings of the Japanese Patent Unexamined Publication No. H11-27907. Miniature commutator motors used in vacuum cleaners often employ the windings placed both inside and outside the diameter of the commutators, so that the improved short α-shape method cannot still solve the problem. On the contrary, use of the short α-shape method limits an amount of windings, so that the motor occasionally loses the primary performance.

### DISCLOSURE OF INVENTION

A commutator motor of the present invention comprises the following elements:
a field magnet including a field magnet core and a field magnet winding; and
an armature including a rotary shaft, an armature core fixed to the rotary shaft, a commutator, and an armature winding wound on slots of the armature core.

The commutator has commutator segments integer multiples of the number of slots and the same number of hooks as the commutator segments. The connecting wire is disposed between the armature winding and the hooks such that at least one of start and end of winding is bent and shaped toward the rotary shaft.

The foregoing structure allows reducing the copper loss of the armature, so that a downsized and efficient commutator motor is obtainable.

A method of manufacturing the foregoing commutator motor comprises the steps of:
winding a wire plural turns on a pair of slots;
winding a next wire plural turns to another pair of slots with a connecting wire being formed;
bending and shaping the connecting wire toward a rotary shaft;
connecting the connecting wire to a hook; and
press fitting the commutator again on the rotary shaft with the bent section of the winding maintained by a winding-shaping jig.

The foregoing manufacturing method allows simple manufacturing steps to provide high quality of the commutator motors with the connecting state of windings to the commutator maintained.

### BRIEF DESCRIPTION OF DRAWINGS

FIG. 1 shows a sectional view in half for illustrating an overall structure of a commutator motor of the present invention.

FIG. 2 shows a lateral view of an armature of the commutator motor shown in FIG. 1.

FIG. 3 shows an external appearance illustrating an essential part of connecting wires of the present invention.

FIGS. 4, 5 and 6 schematically illustrate comparative ones with what is shown in FIG. 3.

FIG. 7 illustrates wire connection of the present invention.

FIGS. 8 and 9 schematically illustrates comparative ones with what is shown in FIG. 7.

FIG. 10-FIG. 13 show a part of a winding step of the present invention and illustrate an end of the winding.

FIG. 14-FIG. 16 show a part of a winding step of the present invention and illustrate a start of the winding.

FIG. 17 shows a lateral view illustrating a part of repress-fitting step of the present invention.

FIG. 18 shows a partial external appearance illustrating a conventional wire-connection (α-shape hooking method).

FIG. 19 shows a partial external appearance illustrating a conventional wire-connection (U-shape hooking method).

FIG. 20 shows a sectional view illustrating a conventional connecting-wire method (short α-shape).

FIG. 21 shows a sectional view illustrating a conventional connecting-wire method (long α-shape).

### DETAILED DESCRIPTION OF PREFERRED EMBODIMENT

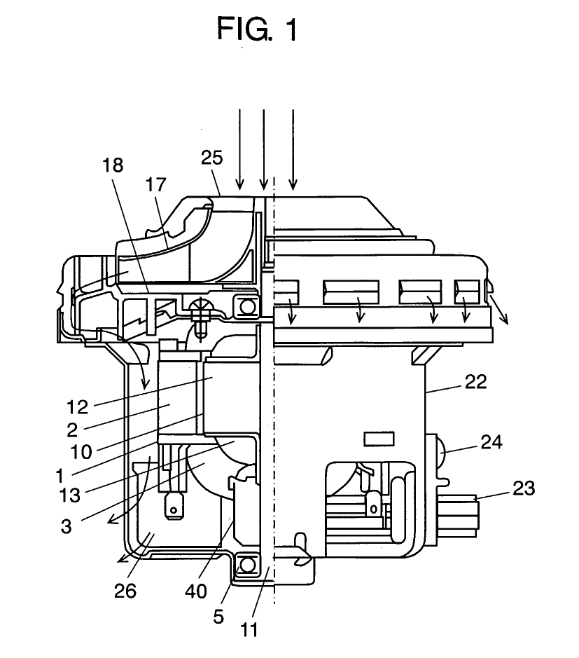

An embodiment of the present invention is described hereinafter with reference to the accompanying drawings. FIG. 1 shows an overall structure of the present invention. In FIG. 1, field magnet 1 is formed by providing field magnet core 2 with field magnet winding 3. Armature 10 is formed by providing armature core 12 fixed to rotary shaft 11 with armature winding 13, and mounting commutator 40 on shaft 11, then supported rotatably by bearings 5 provided at both the ends of rotary shaft 11.

Field magnet 1 is fixed to bracket 22, and a pair of carbon brushes (not shown) are fixed to bracket 22 with screw 24 via brush holder 23. Rotary shaft 11 is equipped with rotary fan 17, and air-guide 18 is placed around and under fan 17 for forming an air duct.

When the foregoing construction is powered, a current supplied from field magnet winding 3 runs to commutator 40 via a carbon brush (not shown). Force is produced between magnetic flux generated by field magnet core 2 and the current running on armature winding 13, thereby rotating armature 10. Rotating of armature 10 spins fan 17, so that air sucked from suction port 25 travels along the arrow marks for cooling armature 10, field magnet 1, and the carbon brush before the air is discharged from exhaust port 26 of bracket 22.

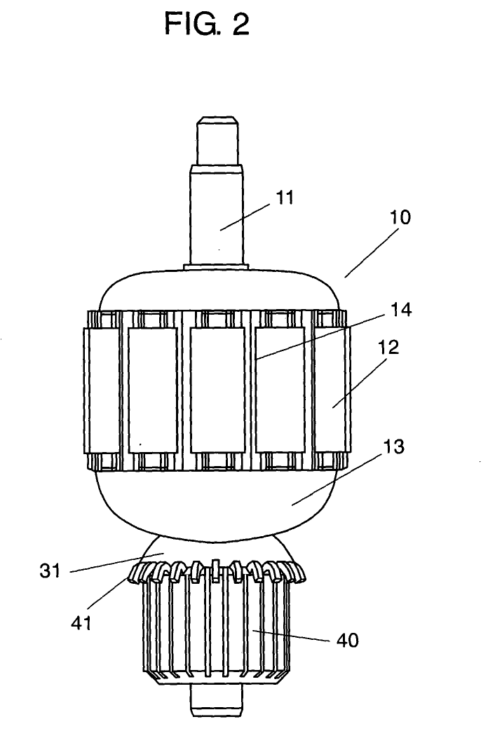

FIG. 2 details armature 10 described in FIG. 1 of the present invention. Armature core 12 and commutator 40 are joined on rotary shaft 11 by press-fitting or shrink-fitting method. Armature core 12 is wound with armature winding 13, which is coupled to hook 41 of commutator 40 via connecting wire section 31. The term of “armature winding” is used hereinafter as distinguished from the field magnet winding, otherwise, it is referred to simply as “winding”.

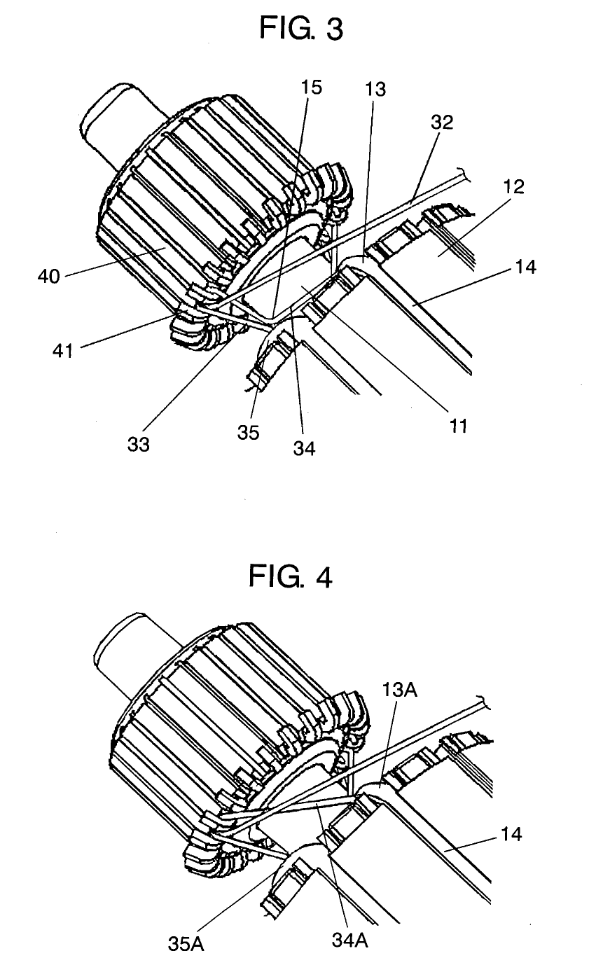

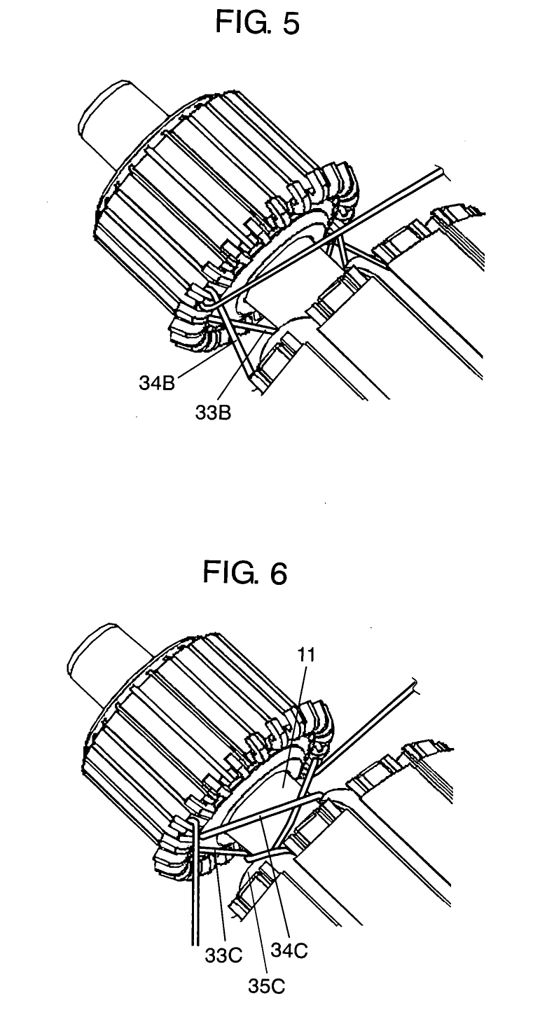

FIG. 3 details an essential part of the embodiment of the present invention. FIGS. 4, 5, and 6 show comparative ones with what is shown in FIG. 3 in accordance with the embodiment of the present invention. They illustrate a winding process of connecting wire section 31 shown in FIG. 2. FIGS. 3 and 4 illustrate an open short α-shape method of connecting wire, FIG. 5 illustrates a regular short α-shape connecting-wire method, and FIG. 6 illustrates a long α-shape connecting-wire method. Armature core 12 has 12 pieces of slots 14, and winding 13 is wound in the distributed winding manner. Commutator 40 has 24 pieces of commutator segment, each one of segments is equipped with hook 41 for connecting to an end of a connecting-wire.

An armature core having an even number of slots often employs a double flier method for winding, namely, a pair of windings confronting each other are sequentially coupled to the commutator hooks, and at the same time, wound successively on the armature core at its slots, thereby forming the armature winding. In FIG. 3, wire 32 coupled to commutator hook 41 forms connecting-wire 33 and runs to a pair of slots 14, then wire 32 is wound plural turns on slots 14, thereby forming winding 13, then forms connecting-wire 34 and is coupled to the adjacent next hook 41. When wire 34 is coupled to hook 41, it is bent and shaped along rotary shaft 11, so that bent section 15 shown in FIG. 3 is formed.

If the connecting wire is not bent, wire 34A is stretched straight in the air as shown in FIG. 4, so that wire 34A blocks the next winding 13A to be wound inside wire 34A. As a result, winding 13A is insufficiently accommodated in slot 14, or coil-end 35A near the commutator becomes abnormally high.

As shown in FIG. 5, connecting-wires 33B and 34B are stretched straight in the air by the regular short α-shape method, so that the next winding is blocked by these connecting wires as illustrated in FIG. 4. As shown in FIG. 6, connecting-wires 33C, 34C wind around rotary shaft 11 by the long α-shape method, so that coil-end 35C near the commutator becomes thick.

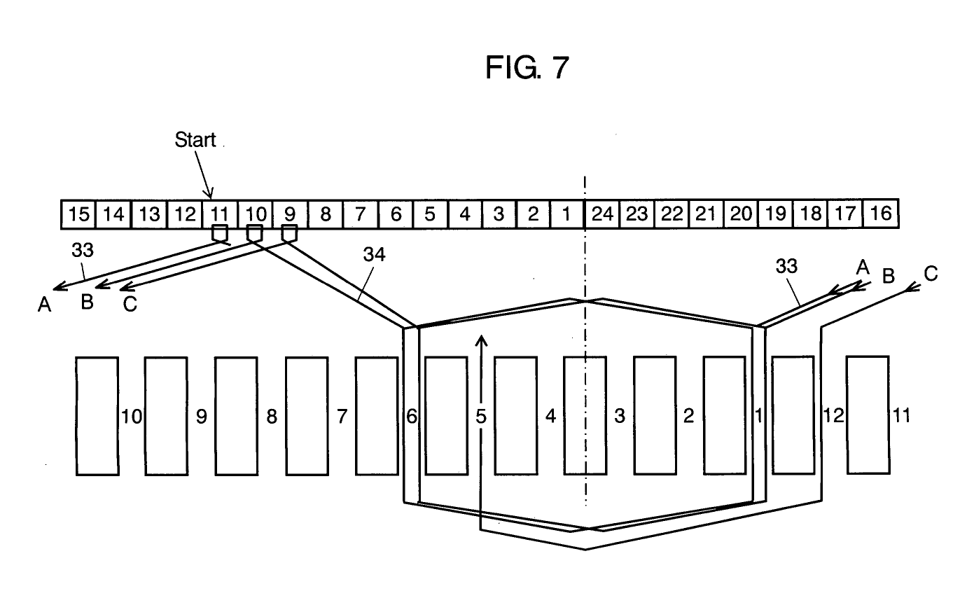

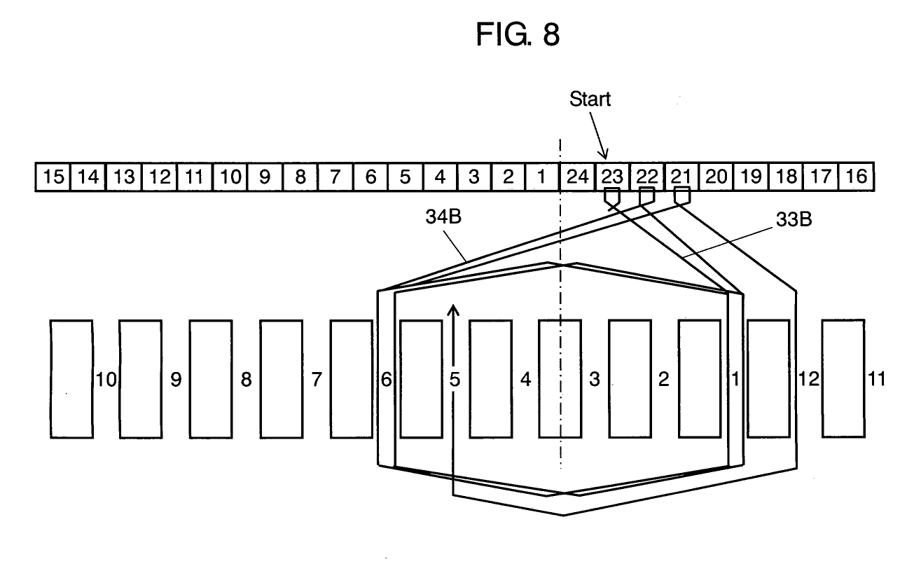

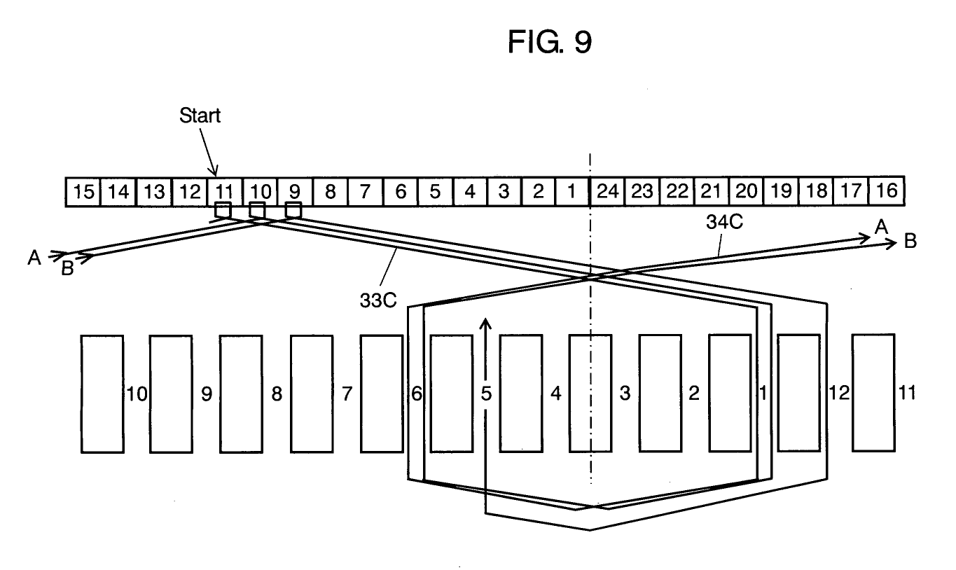

FIG. 7 shows wire connections in accordance with this embodiment. FIGS. 8 and 9 show comparative ones with what is shown in FIG. 7. FIG. 8 shows the regular short α-shape method corresponding to that shown in FIG. 5, and FIG. 9 shows the long α-shape method corresponding to that shown in FIG. 6.

The wire-connections shown in FIGS. 7, 8 and 9 are used in a motor having armature core 12 with 2 poles, 12 slots and commutator 40 with 24 segments. The number of commutator segments integer multiples of the number of the slots. In those drawings, the belt shown in the upper section of each one of the drawings is a development of commutator 40 and the development illustrates 24 hooks. The blocks shown in the lower section of each one of the drawings are core slots 14, and the blocks show the positions of 12 slots. In FIG. 7, the winding starts at hook No. 11 which is marked with “start”, and forms connecting-wire 33 running along arrow-mark A, then enters in slot No. 1, on which the wire is to be wound, and wound plural turns on two slots, i.e. slot No. 1 and slot No. 6. The wire then forms connecting-wire 34 and connects to hook No. 10, and is wound again on slot No. 1 and slot No. 6 before connecting to hook No. 9. Then the wire runs through slot No. 12 and winds on slots No. 12 and No. 5. The wire repeats steps similar to the foregoing ones onward.

FIG. 8 shows a comparative wire-connection with the one shown in FIG. 7. The winding starts with connecting to hook No. 23 marked with “start”, then forms connecting-wire 33B and runs into slot No. 1, and winds on two slots, i.e. slot No. 1 and slot No. 6 plural turns. The wire forms connecting-wire 34B running to hook No. 22, and connects to hook No. 22, then winds on slot No. 1 and slot No. 6 again before connecting to hook No. 21. The wire then runs to slot No. 12, and winds on slot No. 12 and slot No. 5. The wire repeats steps similar to the foregoing ones onward.

FIG. 9 also illustrates a comparative one with what is shown in FIG. 7. The winding starts with connecting to hook No. 11 marked with “start”, then forms connecting-wire 33C and runs into slot No. 1, and winds on two slots, i.e. slot No. 1 and slot No. 6 plural turns. The wire forms connecting-wire 34C running to hook No. 10 along arrow mark A, and connects to hook No. 10, then winds on slot No. 1 and slot No. 6 again, and runs along arrow mark B and connects to hook No. 9. The wire then runs to slot No. 12, and winds on slot No. 12 and slot No. 5. The wire repeats steps similar to the foregoing ones onward.

In an AC motor, the wire connection by the regular short α-shape method shown in FIG. 8 is equivalent to the wire connection by the long α-shape method shown in FIG. 9. The open short α-shape shown in FIG. 7 in accordance with this embodiment is half regular short α-shape and half long α-shape, namely, it obtains the advantages of those two methods. To be more specific, the open short α-shape method uses the same positional relation between the hook and the slots as that of the long α-shape method, but uses a different route of the connecting-wire, namely, the wire runs along the shortest path, so that the connecting-wire runs closely along the rotary shaft. As a result, the connecting-wire does not block the winding, which is an advantage of the long α-shape method, and one of the start and end of the winding uses this advantage.

A total length of the connecting-wire is examined hereinafter. The connecting-wire indicates a wire extended between a hook to be connected and a slot to be wound, and a subject here is how to shorten the total length of the connecting-wire.

In the case of the regular short α-shape shown in FIG. 8, the sum of each length of connecting wires 33B and 34B is the total length. In this case the wire runs from the hook, to which the wire connects, to the slot, on which the wire is wound, via the shortest way. The total length is thus the shortest among others.

In the case of the long α-shape shown in FIG. 9, the sum of each length of connecting wires 33C and 34C is the total length. In this case the wire runs from the hook, to which the wire connects, to the slot, on which the wire is wound, via the longest way. The total length is thus the longest among others.

In the case of this embodiment shown in FIG. 7, the sum of each length of connecting wires 33 and 34 is the total length. This case somewhat looks like the regular short α-shape; however, the embodiment has a longer distance between the hook and the slot than that of the regular short α-shape, and yet, this case has the bent section which is a feature of the present invention. The total length thus becomes longer than that of the regular short α-shape shown in FIG. 8, but shorter than that of the long α-shape shown in FIG. 9.

In the case of 2 poles motors which have the longest coil-end among other types of motors, if a 2 poles motor employs the long α-shape, the connecting-wire runs along coil-end 35C near the commutator for wire-connection, so that a length of the wire becomes extraordinarily long, which adversely affects the copper loss. Use of the open short α-shape of the present invention thus substantially improves the efficiency of the motor.

Solving the problems caused by a long connecting-wire eventually reduces the volume of the coil-end between the commutator and the core-end nearer to the commutator, and allows forming an armature winding with the minimized volume of the coil-end near the commutator. The bent connecting-wire of the open short α-shape is stretched straight between the hook and bent point 15, so that below commutator 40 becomes totally open. After the winding step, this open space allows another process to shorten the distance between the commutator and the core, so that the armature can be downsized.

The bent-shaped section has a smaller outer diameter than that of the commutator, and the bent-shaped section thus can be bound with a string to the rotary shaft, thereby preventing the bent section from being deformed at the repress-fitting step described later.

The open short α-shape produces room over the coil-end, and sheets of core thus can be further piled up, so that the lamination of armature core 12 can be thickened for higher efficiency. As a result, the motor of higher efficiency is obtainable without upsizing external dimensions along the shaft.

FIG. 3 shows an example of shorter connecting-wire 34 formed when an end of winding 13 connects to hook 41; however, there is another specification of wire connection, i.e. shorter connecting-wire 33 is formed when a start of the winding runs to slot 14, on which the wire is wound. In this case, when wire 33 moves to the winding position after connecting to hook 41, connecting-wire 33 is bent and shaped before starting the winding step, so that an advantage similar to what is discussed previously is obtainable.

The foregoing discussion proves that the present invention solves the wire-connection problems caused by regular wire-connection methods such as the long α-shape and the short α-shape used at the armature winding of the miniature commutator motor used in vacuum cleaners, and keeps the volume down of the coil-end near the commutator. The copper loss of the armature thus can be reduced, so that the miniature commutator motor of higher efficiency is achievable.

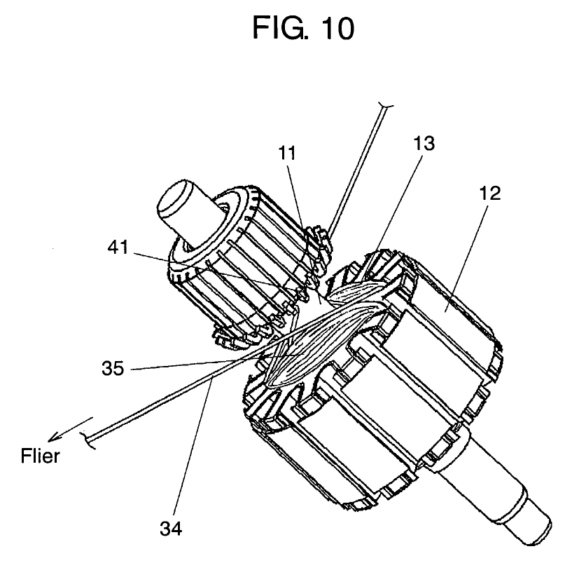

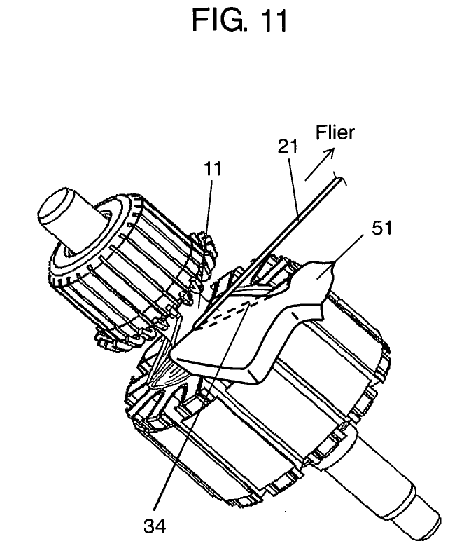

A method of manufacturing the bent and shaped connecting-wire discussed above is demonstrated hereinafter. FIGS. 10-13 show external views respective steps of bending and shaping the end of the winding to form a connecting-wire. Forming device (called “former”) related components which block the illustration of the external views are omitted.

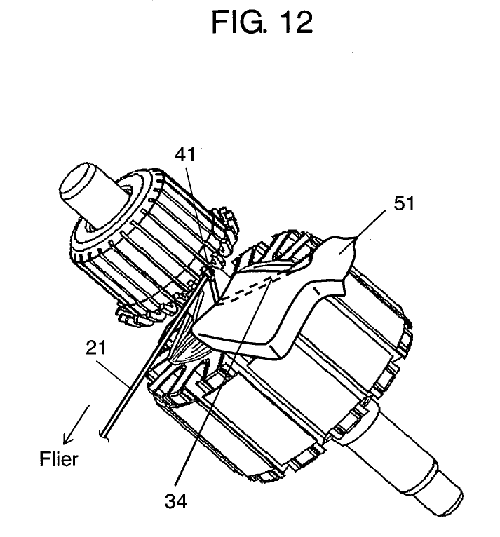

FIG. 10 shows armature core 12 rotated from a place where winding 13 finishes winding on slots to a place where the wire is to be hooked on hook 41. Connecting-wire 34 formed of the end of the winding continued from the flier is positioned along coil-end 35 and rotary shaft 11. FIG. 11 shows former 51 to be used for shaping a connecting-wire advances and urges connecting-wire 34 toward rotary shaft 11. In this status, extreme stress for bending wire 21 is not applied to connecting-wire 34.

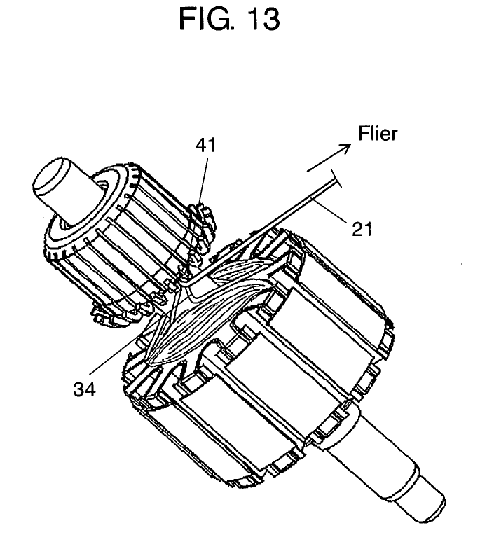

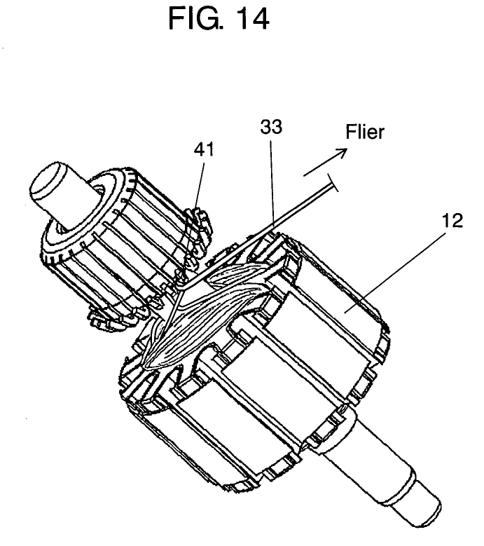

FIG. 12 shows that wire 21 is hooked on hook 41 by moving the flier. In this status, connecting-wire 34 is bent by former 51; however, connecting-wire 34 is just bent along former 51 and moved, so that extreme stress for forming the bent section is not applied to wire 34. FIG. 13 shows that connecting-wire 34 forms the α-shape wire-connection on hook 41 by rotating the flier. Wire 21 hooked on hook 41 is bent by an edge of hook 41, so that wire 21 is positioned there steadily. Removal of former 51 thus still maintains connecting-wire 34 bent as it is before wire 34 undergoes the next step.

FIGS. 14-16 show external views illustrating respective winding steps which bend the connecting-wire formed of the start of the winding. Former related components which block the illustration of the external views are omitted. FIG. 14 shows that wire 33 is wound on a pair of slots, then hooked on hook 41. Then armature core 12 is rotated to another pair of slots where the next winding is to be wound.

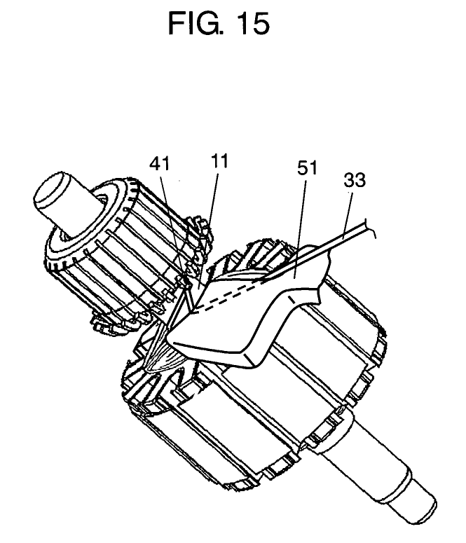

FIG. 15 shows former 51 to be used for shaping a connecting-wire advances and urges connecting-wire 33 toward rotary shaft 11. This status is achieved by being in step with the rotation of the flier, and extreme load for forming the bent section is not applied to wire 33.

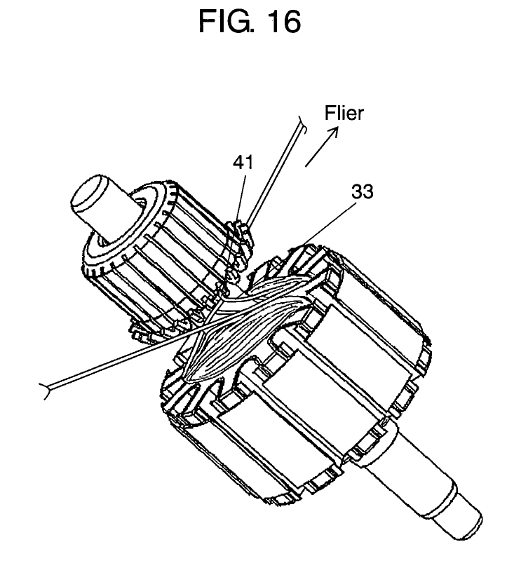

FIG. 16 shows a status where former 51 is removed. When the wire is led into a pair of slots by the rotation of the flier, connecting-wire 33 is fixed, so that even if former 51 is removed, connecting-wire 33 having undergone the bending and shaping processes is maintained as it is (bent and shaped) and enters to the next winding step.

As discussed above, the steps of this embodiment do not damage the connecting-wire and form the bent section with ease, so that the connecting-wire does not block the next winding, so that the coil-end volume can be minimized.

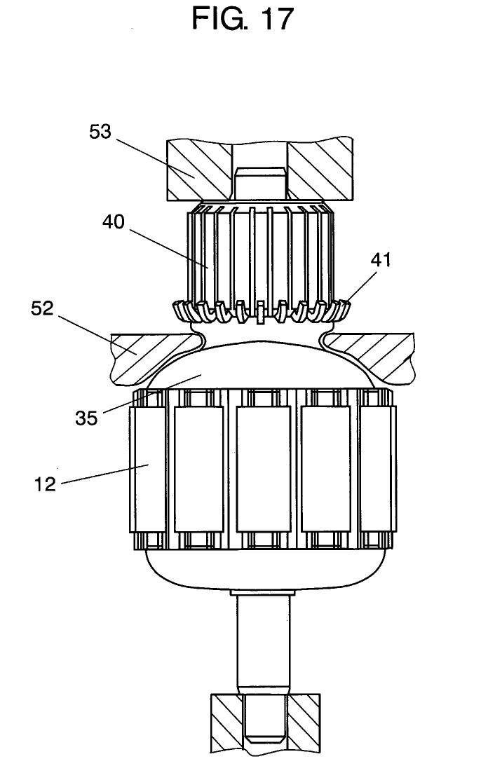

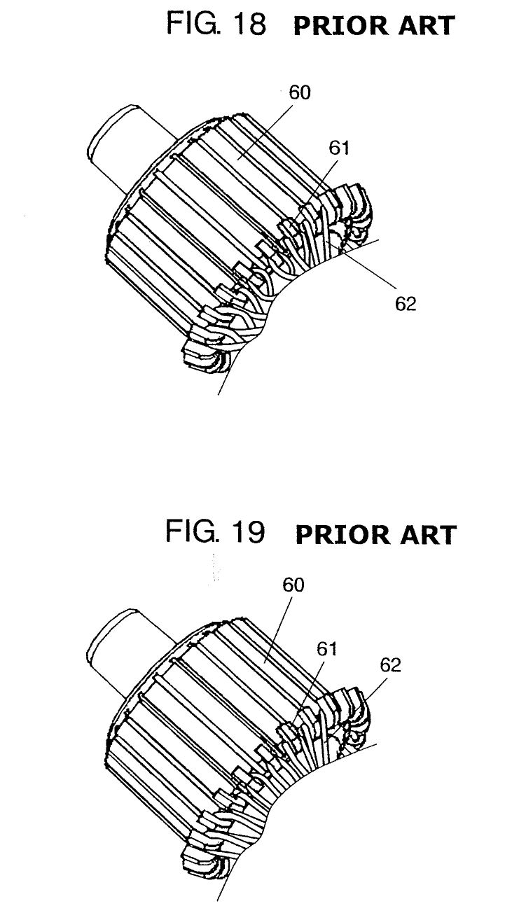

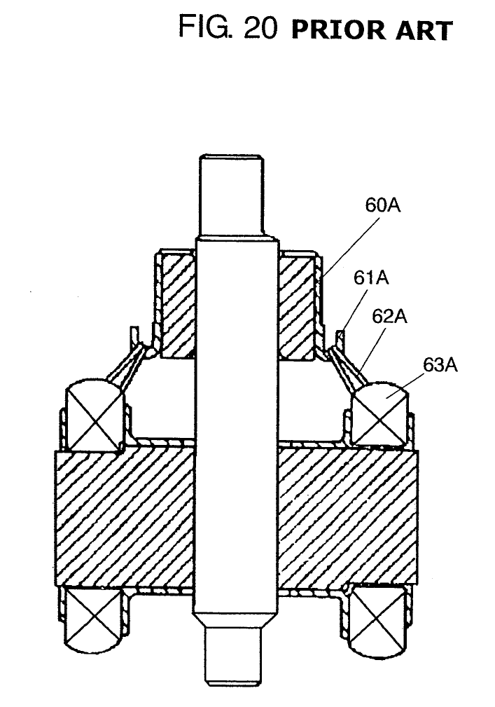

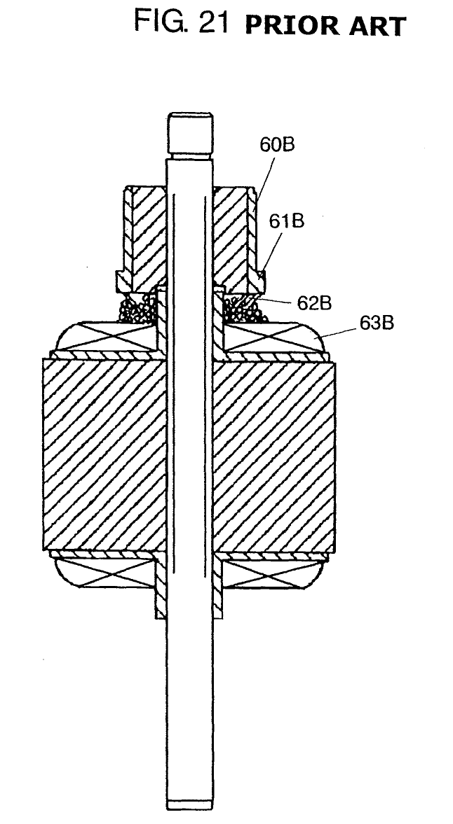

FIG. 17 shows a partial lateral view illustrating the step of forming the coil end near the commutator and the step of repress-fitting the commutator to a final position. Jig-related components which block the illustration of the external views are omitted.

In order to downsize the commutator motor, the space between commutator 40 and armature core 12 needs to be short enough to accommodate the coil volume. In winding, the space between commutator 40 and armature core 12 is widened, and after the winding, commutator 40 is repress-fitted to its final position so that dimensions of the product can be ensured. The step of accommodating the coil-end, which bulges due to turns of winding, in specified dimensions is demonstrated hereinafter. At the same time, the step of repress-fitting commutator 40 is demonstrated.

In FIG. 17, jig 52 to be used for shaping the connecting-wire is inserted into a space between commutator 40 and coil-end 35 so that the bent and shaped status of the connecting-wire can be maintained. Meanwhile, jig 52 has been formed to fit the shape of the bent connecting-wire. Then jig 52 urges coil-end 35 toward armature core 12, and at the same time, commutator pressing jig 53 presses commutator 40 for repress-fitting to its final position. Maintaining the bent and shaped status of the connecting-wire allows preventing the wire hooked on hook 41 from being deformed, and both of shaping coil-end 35 and repress-fitting commutator 40 are carried out simultaneously. These simultaneous actions are important, because if shaping coil-end 35 is carried out ahead of repress-fitting, the wire hooked on hook 41 is stretched, which invites critical defects such as wire-break at connecting sections.

The steps discussed above allows maintaining a relation between hook 41 and the bent connecting-wire until the motor is completely assembled, so that the connection between the hooks and the winding having undergone the wire-connection process is maintained, and thus the quality of the motor is assured.

### INDUSTRIAL APPLICABILITY

A commutator motor of the present invention can use a substantially downsized coil-end volume comparing with that of a short α-shape wire-connection or a long α-shape wire-connection, and yet, winding can be done to the motor more efficiently. This construction allows reducing the copper loss of the armature, so that a downsized and highly efficient commutator motor is obtainable.

### REFERENCE NUMERAL IN THE DRAWINGS

1 Stator
2 Field magnet core
3 Field magnet winding
10 Rotor
11 Rotary shaft
12 Armature core
13 Armature winding
14 Slot
33, 34 Connecting-wire
40 Commutator
41 Hook
51 Former for shaping a connecting-wire
52 Jig for shaping a winding
53 Commutator pressing jig

1. A commutator motor comprising:
a field magnet including a field magnet core and a field magnet winding; and
an armature including a rotary shaft, an armature core fixed to the rotary shaft, an armature winding wound on a plurality of slots of the armature core, and a commutator,
wherein the commutator has commutator segments integer multiples of a number of the plurality of slots and an identical number of hooks to the segments, and
a connecting-wire between the armature winding and the hooks is bent and shaped toward the rotary shaft at least at a place one of a start of winding and an end of winding of the armature winding.

2. The commutator motor of claim 1, wherein the connecting-wire connects to the hook in α-shape.

3. The commutator motor of claim 1, wherein the connecting-wire is rigidly bound with a string.

4. A method of manufacturing a commutator motor, which motor comprises:
a field magnet including a field magnet core and a field magnet winding;
an armature including a rotary shaft, an armature core fixed to the rotary shaft, an armature winding wound on a plurality of slots of the armature core, and a commutator having a hook to which the armature winding is connected,
the method comprising the steps of
(a) providing a pair of the slots with a winding plural turns;
(b) forming a connecting-wire and providing another pair of the slots with a winding plural turns;
(c) bending and shaping the connecting-wire toward the rotary shaft;
(d) connecting the connecting-wire to the hook; and
(e) repress-fitting the commutator on the rotary shaft while the bent and shaped section of the winding is maintained with a winding-shaping jig.

5. The method of manufacturing a commutator motor as defined in claim 4, wherein the step (c) bends and shapes the connecting-wire at least at a place one of a start of winding and an end of winding of the armature winding.

6. The method of manufacturing a commutator motor as defined in claim 4, wherein the step (c) includes a step of moving a former to be used for forming the connecting-wire along a direction from an outer circumference of the armature core toward the rotary shaft.

7. The method of manufacturing a commutator motor as defined in claim 4, wherein the step (d) connects the connecting-wire to the hook in α-shape.

8. The method of manufacturing a commutator motor as defined in claim 4, further comprising the step of:
rigidly binding the connecting-wire with a string.

9. The method of manufacturing a commutator motor as defined in claim 4, wherein the winding-shaping jig urges the bent and shaped section from a radial direction toward the rotary shaft.

10. The method of manufacturing a commutator motor as defined in claim 4, wherein the step (e) including a step of urging the commutator to axial direction with a commutator-pressing jig.
